(19) United States
(12) Patent Application Publication
(10) Pub. No.: US 2006/0139404 A1
(43) Pub. Date: Jun. 29, 2006

(54) Opening detection device and method thereof

(75) Inventor: Kuo-Tong Ma, Taipei (TW)

Correspondence Address: BIRCH STEWART KOLASCH & BIRCH, PO BOX 747, FALLS CHURCH, VA, 22040-0747, US

(73) Assignee: BENQ CORPORATION, Taoyuan (TW)

(21) Appl. No.: 11/297,344

(22) Filed: Dec. 9, 2005

(30) Foreign Application Priority Data
Dec. 13, 2004 (TW) 93138583

(51) Int. Cl. B41J 2/16

(52) U.S. Cl. 347/47

(57) ABSTRACT

An opening detection device. The device includes a substrate, a structural layer formed on the substrate, and an opening detection circuit above or below the structural layer comprising a conductor situated where an opening is subsequently formed and a conductive wire connecting the conductor. A method of detecting an opening is also disclosed.

### BACKGROUND

The present invention relates to a detection device, and more specifically to an opening detection device and a method of detecting an opening.

Currently, fluid injection is widely used in various technological products, such as ink jet printheads, fuel oil injection devices, and pharmaceutical injection mechanisms.

Quality of openings may significantly affect fluid injection, thus, it has been advantageous to develop an accurate and simple method of monitoring opening quality to improve injection. A related fluid injection device is disclosed in U.S. Pat. No. 6,102,530, and illustrated in FIG. 1. The fluid injection device comprises a silicon substrate 38, a manifold 26 to transport fluid, a plurality of chambers 14 installed on one side of the manifold 26 to contain fluid, a plurality of nozzles 18 installed on the surface of the chambers 14 to inject fluid, and injection elements 20 and 22 installed around the nozzles 18.

Detection of each small-diameter nozzle of such device structures using a conventional optic microscope can be time-consuming and often results in erroneous estimation, decreasing yield. Further, the conventional detecting method is not suitable for detection of exceptional nozzle shapes as disclosed in U.S. Pat. No. 6,254,219 or a trapezoidal nozzle as disclosed in U.S. Pat. No. 5,417,897.

### SUMMARY

The invention provides an opening detection device comprising an opening detection circuit to precisely recognize shape, position, and depth of a nozzle.

The invention provides an opening detection device comprising a substrate, a structural layer formed on the substrate, and an opening detection circuit installed above or below the structural layer, wherein the opening detection circuit comprises a conductor situated where an opening is subsequently formed and a conductive wire connecting the conductor.

After nozzles are formed, conductors formerly situated at nozzle positions may be partially or totally removed, causing resistance variation therein. Characteristics of nozzles, such as shape, position, and depth, can thus be obtained by detecting the resistance variation.

The invention provides a method of detecting an opening, comprising the following steps. First, a substrate is provided. A conductive layer is then formed on the substrate. Subsequently, the conductive layer is etched to form an opening detection circuit comprising a conductor situated where an opening is subsequently formed and a conductive wire connecting the conductor. An opening through the conductive layer is finally formed. The position of the opening is then recognized by detecting resistance variation of the conductor.

The invention provides a convenient method of fabricating an opening detection circuit, that is, a conductor and a conductive wire are simultaneously formed when a conductive layer or a resist layer is etched. Additionally, small-diameter or exceptionally shaped openings are easily detected by the method.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross section of a fluid injection device as disclosed in U.S. Pat. No. 6,102,530.

FIGS. 2a-2d are cross sections of a method of fabricating a fluid injection device of the invention.

FIGS. 3a-3d are cross sections of another method of fabricating a fluid injection device of the invention.

FIGS. 4a-4c are cross sections of another method of fabricating a fluid injection device of the invention.

FIGS. 5a-5h are top views of conductors of the invention.

FIGS. 6a and 6b show a comparison between different opening qualities.

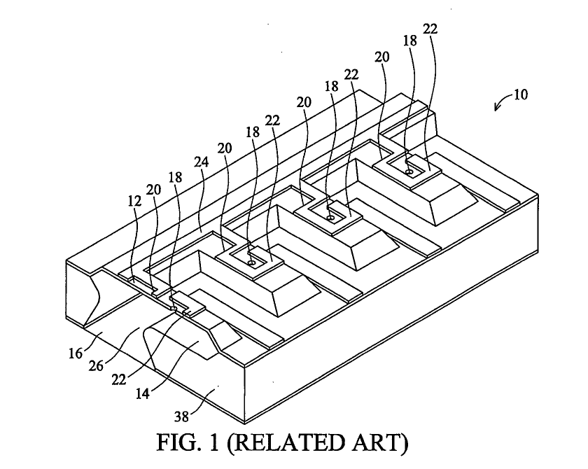

### DETAILED DESCRIPTION OF THE INVENTION

A first opening detection circuit features a conductor and a conductive wire formed in a conductive layer installed on a structural layer, with the conductor situated where an opening is subsequently formed.

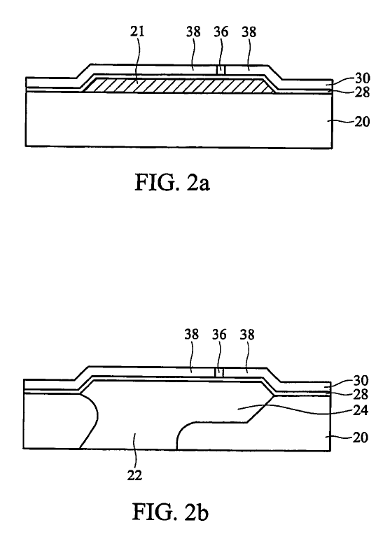

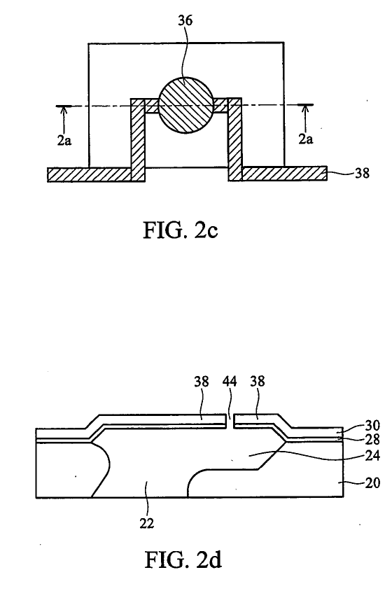

A device structure comprising the above opening detection circuit is illustrated in FIG. 2a and 2c, wherein FIG. 2c is a top view of the opening detection circuit, and FIG. 2a is a cross section along the tangent line 2a-2a of FIG. 2c. Referring to FIG. 2a, the device comprises a substrate 20, a sacrificial layer 21, a structural layer 28, and a conductive layer 30, wherein the conductive layer 30 comprises a conductor 36 and a conductive wire 38 connecting the conductor 36, and the conductor 36 is situated where a nozzle is subsequently formed.

The sacrificial layer 21 is formed on the substrate 20. The structural layer 28 covers the substrate 20 and the sacrificial layer 21. The conductive layer 30 is formed on the structural layer 28. The conductive layer 30 comprises the conductor 36 and the conductive wire 38 connecting the conductor 36.

Referring to FIG. 2a, a method of fabricating the opening detection device is provided. First, a substrate 20 is provided, such as a silicon substrate. The thickness of the substrate 20 is about 625˜675 μm. Subsequently, a patterned sacrificial layer 21 is formed on the substrate 20. The sacrificial layer 21 comprises BPSG, PSG, or silicon oxide, preferably PSG. The thickness of the sacrificial layer 21 is about 1-2 μm.

The patterned sacrificial layer 21 is a predetermined region of chambers. Next, a structural layer 28 is formed on the substrate 20 to cover the patterned sacrificial layer 21. The structural layer 28 may be silicon carbide, silicon nitride, silicon oxide, poly-methylmethacrylate (PMMA), or polymer. Next, a conductive layer 30 is formed on the structural layer 28. A patterned conductive layer 30 comprising a conductor 36 and a conductive wire 38 connecting the conductor 36 is formed after the conductive layer 30 is exposed, developed, and etched, wherein the conductor is situated at the position where a nozzle is subsequently formed. The conductive layer 30 is a semiconductor.

When the conductive layer 30 is etched, a circuit layout comprising a conductor 36 and the conductive wire 38 connecting the conductor 36 is simultaneously formed therein, as shown in FIG. 2c. The conductor 36 is situated where a nozzle is subsequently formed. Thus, no extra materials or processes are required, providing a convenient method for fabricating an opening detection device.

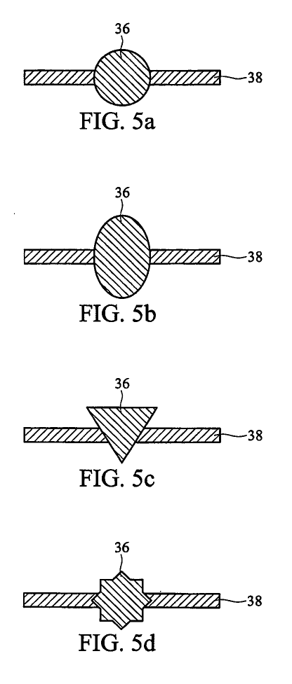

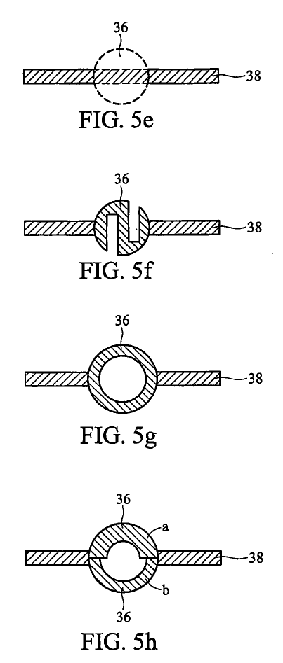

The conductor 36 may be circular, elliptical, polygonal, such as triangular, linear, serpentine, or a combination thereof, as shown in FIG. 5a-5f. The conductor 36 can further be annular, as shown in FIG. 5g and 5h. The annular conductor larger than a nozzle illustrated in FIG. 5g and having various widths illustrated in FIG. 5h, such as a>b (represents the conductor resistance of the region a is less than the region b) can be used to recognize the position of a subsequently formed nozzle.

Subsequently, a series of etching steps are performed. Referring to FIG. 2b, first, the back of the substrate 20 is etched to form a manifold 22 by anisotropic wet etching using KOH as an etching solution, exposing the sacrificial layer 21.

The narrow opening width of the manifold 22 is about 160-200 μm, and the wide opening width thereof is about 100-1200 μm. The included angle between the side wall of the manifold 22 and a horizontal factor is about 54.74°. Therefore, after etching, a manifold 22 with a back opening larger than a front opening is formed. Additionally, the manifold 22 connects to a fluid storage tank.

Next, the sacrificial layer 21 is removed by HF, and the substrate 20 is subsequently etched by a basic etching solution, such as KOH, to enlarge the vacant volume thereof, forming a chamber 24.

Finally, the conductive layer 30 and the structural layer 28 are etched in order by plasma etching, chemical vapor etching, laser etching, or reactive ion etching (RIE) to form a nozzle 44 connecting to the chamber 24, as shown in FIG. 2d. The size and position of the nozzle 44 can thus be obtained by detecting resistance variation of the conductor 36.

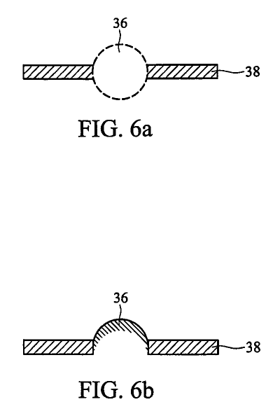

If the conductor 36 is totally removed, leaving only the conductive wire 38, as shown in FIG. 6a, the resistance of the conductor 36 may drop to zero, resulting in maximum quality of the nozzle 44. On the contrary, if the conductor 36 is partially removed, as shown in FIG. 6b, resistance in the conductor 36 may be generated, which poor quality of the nozzle 44 is detected.

A second opening detection circuit features a conductor and a conductor wire formed in a resist layer installed on a structural layer, with the conductor is situated where an opening is subsequently formed. The distinction between the first and second detection circuits is that the first detection circuit is installed in a conductive layer, but the second detection circuit is installed in a resist layer.

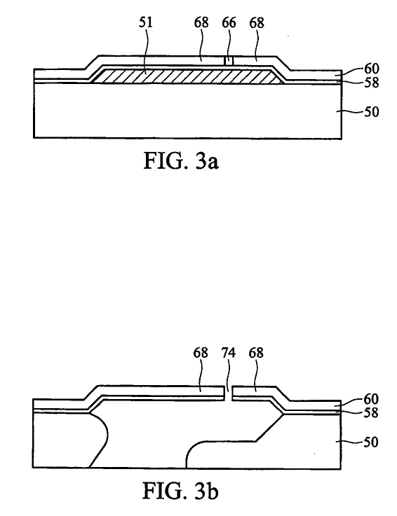

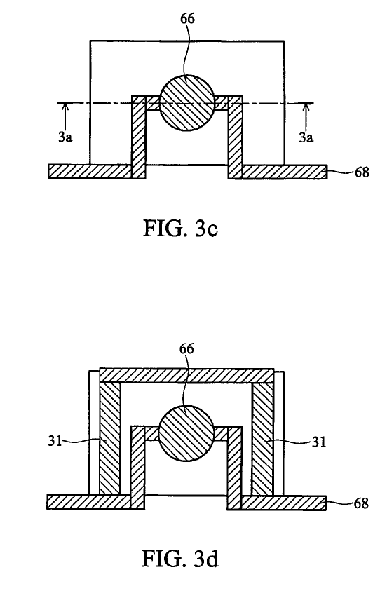

A device structure comprising the second opening detection circuit is illustrated in FIG. 3a and 3c, wherein FIG. 3c is a top view of the opening detection circuit, and FIG. 3a is a cross section along the tangent line 3a-3a of FIG. 3c. Referring to FIG. 3a, the device comprises a substrate 50, a sacrificial layer 51, a structural layer 58, and a resist layer 60, wherein the resist layer 60 comprises a conductor 66 and a conductive wire 68 connecting the conductor 66, with the conductor 66 situated where a nozzle is subsequently formed.

The structural layer 58 covers the substrate 50 and the sacrificial layer 51. The resist layer 60 is installed on the structural layer 58. The resist layer 60 comprises a plurality of fluid actuators, such as heaters, driving fluid out of nozzles. The resist layer 60 further comprises a conductor 66 and a conductive wire 68 connecting the conductor 66.

Referring to FIGS. 3a and 3b, a method of fabricating the opening detection device is provided. The fabrication methods of the opening detection devices illustrated in FIG. 2a and FIG. 3a are similar. The distinction there between is merely the position where an opening detection circuit is formed. Additionally, the heaters and the opening detection circuit are simultaneously formed in the resist layer 60. The resist layer 60 comprises HfB₂, TaAl, TaN, or TiN, preferably TaAl.

When the resist layer 60 is etched, a circuit layout comprising a conductor 66 and the conductive wire 68 connecting the conductor 66 is simultaneously formed therein, as shown in FIG. 3c. The conductor 66 is situated where a nozzle is subsequently formed. Additionally, the heaters and the opening detection circuit are simultaneously formed. Thus, no extra materials or processes are required, providing a convenient method for fabricating an opening detection device.

The shapes and sizes of the conductors 36 and 66 may be the same. Further, the second opening detection circuit may connect with the heater 31 to form a parallel connection, as shown in FIG. 3d.

After the fabrication of the second detection device is completed, the size and position of the nozzle 74 are also obtained by detecting resistance variation of the conductor 66.

A third opening detection circuit features a conductor and a conductive wire formed in a conductive layer installed below a structural layer, with the conductor situated where an opening is subsequently formed. The distinction between the third and second detection circuits is that the third detection circuit is installed below the structural layer, but the second is installed above the structural layer, and the third detection circuit is situated at the etching end-point of an opening.

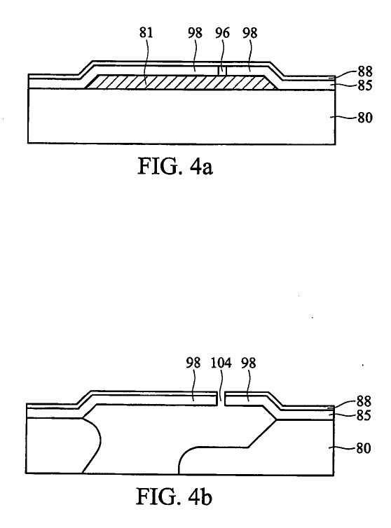

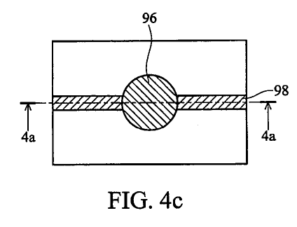

A device structure comprising the third opening detection circuit is illustrated in FIG. 4a and 4c, wherein FIG. 4c is a top view of the opening detection circuit, and FIG. 4a is a cross section along the tangent line 4a-4a of FIG. 4c. Referring to FIG. 4a, the device comprises a substrate 80, a sacrificial layer 81, a conductive layer 85, and a structural layer 88, wherein the conductive layer 85 below the structural layer 88 comprises a conductor 96 and a conductive wire 98 connecting the conductor 96, and the conductor 96 is situated at where a nozzle is subsequently formed.

The conductive layer 85 covers the substrate 80 and the sacrificial layer 81. The structural layer 88 is formed on the conductive layer 85. The conductive layer 85 comprises a conductor 96 and a conductive wire 98 connecting the conductor 96.

Referring to FIGS. 4a and 4b, a method of fabricating the opening detection device is provided. The fabrication methods of the opening detection devices illustrated in FIG. 3a and FIG. 4a are similar. The distinction therebetween is merely the position where an opening detection circuit is formed. The third detection circuit is formed in the conductive layer 85 below the structural layer 88.

When the conductive layer 85 is etched, a circuit layout comprising a conductor 96 and the conductive wire 98 connecting the conductor 96 is simultaneously formed therein, as shown in FIG. 4c. The conductor 96 is situated at the position where a nozzle is subsequently formed. Thus, no extra materials or processes are required, providing a convenient method for fabricating an opening detection device.

The shapes and sizes of the conductors 66 and 96 may be the same. After the fabrication of the third detection device is completed, the size and position of the nozzle 104 are obtained by detecting resistance variation of the conductor 96. Additionally, the depth of the nozzle 104 can also be determined by detection of resistance variation by the conductor 96 at the etching end-point of the nozzle 104.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An opening detection device, comprising:
a substrate;
a structural layer formed on the substrate; and
an opening detection circuit above or below the structural layer, comprising a conductor situated where an opening is subsequently formed and a conductive wire connecting the conductor.

2. The opening detection device as claimed in claim 1, wherein the structural layer comprises silicon nitride, silicon oxide, silicon carbide, polymethylmethacrylate (PMMA), or polymer.

3. The opening detection device as claimed in claim 1, wherein the opening detection circuit is installed between the structural layer and the substrate.

4. The opening detection device as claimed in claim 1, wherein the conductor is a semiconductor.

5. The opening detection device as claimed in claim 1, wherein the conductor is linear, serpentine, circular, elliptical, polygonal, annular, or a combination thereof.

6. The opening detection device as claimed in claim 5, wherein the annular conductor has uniform width.

7. The opening detection device as claimed in claim 5, wherein the annular conductor has varying width.

8. A method of detecting an opening, comprising:
providing a substrate;
forming a conductive layer on the substrate;
etching the conductive layer to form an opening detection circuit comprising a conductor situated where an opening is subsequently formed and a conductive wire connecting the conductor;
forming an opening through the conductive layer; and
detecting resistance variation of the conductor to confirm the position of the opening.

9. The method as claimed in claim 8, further comprising forming a structural layer on the substrate before the conductive layer is formed.

10. The method as claimed in claim 8, wherein the conductive layer is a resist layer.

11. The method as claimed in claim 8, further comprising forming a structural layer on the substrate after the opening detection circuit is formed.

12. The method as claimed in claim 11, wherein the structural layer comprises silicon nitride, silicon oxide, silicon carbide, polymethylmethacrylate (PMMA), or polymer.

13. The method as claimed in claim 8, wherein the conductor is a semiconductor.

14. The method as claimed in claim 8, wherein the conductor is linear, serpentine, circular, elliptical, polygonal, annular, or combination thereof.

15. The method as claimed in claim 14, wherein the annular conductor has uniform width.

16. The method as claimed in claim 14, wherein the annular conductor has varying width.
